(19) United States
(12) Patent Application Publication
(10) Pub. No.: US 2007/0048074 A1
(43) Pub. Date: Mar. 1, 2007

(54) Ring binder mechanism having pivot connector

(76) Inventor: Wing Kit Kwong, Hong Kong (CN)

Correspondence Address: SENNIGER POWERS, ONE METROPOLITAN SQUARE, 16TH FLOOR, ST LOUIS, MO, 63102, US

(21) Appl. No.: 11/216,187

(22) Filed: Aug. 31, 2005

(51) Int. Cl. B42F 3/00

(52) U.S. Cl. 402/70

(57) ABSTRACT

A ring binder mechanism comprises a housing, at least one ring supported by the housing for mounting loose leaf paper, and at least one connector member associated with the housing. A base plate can be attached to a substrate and has a surface adapted to receive the connector member of the ring binder mechanism. A clasp can be moved with respect to the base plate between a release position in which the connector member is unconnected to the base plate and a lock position in which the connector member of the ring binding mechanism is connected to the base plate.

### BACKGROUND OF THE INVENTION

This invention relates to ring binders for retaining loose-leaf pages, and in particular to a fastening system for attaching a ring binder mechanism to a cover to form the ring binder.

Conventional ring binders are made by securing a ring binder mechanism to a cover using rivets. Commonly, ring binder mechanisms include a housing and a plurality of ring members attached to the housing for retaining loose-leaf pages, such as hole-punched pages. Typically, the ring binder mechanism is secured to the cover by inserting the rivets through the cover and openings in the ring binder mechanism. The tail of each of the rivets is then deformed (e.g., by punching) to engage and fasten the ring binder mechanism. Once assembled, the ring binder is packaged and shipped to a distributor, a retailer, or directly to an end user (i.e., consumer).

One of the drawbacks of traditional ring binders relates to their shipping and storage after they are assembled. When assembled, large gaps exist between the ring binder mechanism and the cover for each ring binder leaving large amounts of room unused during shipping and storing of multiple ring binders. Thus, the number of ring binders in each package is greatly limited. As a result, packaging and shipping conventional ring binders is inefficient, which results in significant shipping and handling costs. Moreover, even a limited number of ring binders occupy a substantial amount of storage space or retail display space.

In response to this drawback, manufacturers of ring binders typically pack the mechanisms in alternating directions. But even this packing technique leaves large amounts of unused space. Further efforts to overcome some of the short comings of conventional ring binders have been disclosed in coassigned U.S. Pat. No. 5,924,811 to To et al., U.S. Pat. No. 5,879,097 to Cheng, and U.S. Pat. No. 5,160,209 to Schuessler, all of which are hereby incorporated by reference in their entireties.

### SUMMARY OF THE INVENTION

In one aspect, a ring binder mechanism of the present invention generally comprises a housing, at least one ring supported by the housing for mounting loose leaf paper, and at least one connector member extending outwardly from the housing. A base plate is adapted to be attached to a substrate. The base plate has a surface adapted to receive the connector member of the ring binder mechanism. A clasp is adapted for movement with respect to the base plate between a release position in which the connector member is unconnected to the base plate and a lock position in which the connector member of the ring binding mechanism is connected to the base plate.

In another aspect, the present invention is directed to a fastening system for attaching a ring binder mechanism to a cover. The ring binder mechanism generally has a housing including at least one ring for mounting loose leaf paper and at least one connector member extending outwardly from the housing. The fastening system generally comprises a base plate adapted to be attached to the cover. The base plate has a seat sized and shaped for receiving the connector member of the ring binder mechanism. A clasp is adapted for movement with respect to the base plate between a release position in which the connector member is unconnected to the base plate and a lock position in which the connector member of the ring binding mechanism is connected to the base plate.

In yet another aspect, the present invention is direction to a method of attaching a ring binder mechanism to a cover. The ring binder mechanism generally comprises a housing including at least one ring for mounting loose leaf paper thereon and at least one connector member extending outwardly from the housing. The method generally comprises attaching at least one base plate to the cover. The base plate is adapted to receive a portion of the connector member. The connector member of the ring binder mechanism is engaged with the base plate and a clasp is pivoted with respect to the base plate. The clasp and base plate cooperate to secure the connector member of the ring binder mechanism to the cover.

Other objects and features of the present invention will be in part apparent and in part pointed out hereinafter.

### BRIEF DESCRIPTION OF THE DRAWINGS

FIG. 1 is a fragmentary perspective of a ring binder including a cover and a ring binder mechanism attached to the cover, the ring binder mechanism being attached to the cover using a fastening system of the present invention;

FIG. 2 is the perspective of FIG. 1 with the ring binder mechanism exploded from a spine of the cover;

FIG. 3 is a section taken on line 3-3 of FIG. 1;

FIG. 4 is a bottom side perspective of the ring binder mechanism;

FIG. 5 is an exploded bottom side perspective of the ring binder mechanism;

FIG. 6 is the perspective of FIG. 4 but with the ring members in an open position;

FIG. 7A is an enlarged fragmentary perspective of the ring binder mechanism with a housing removed and showing a lever connected to hinge plates;

FIG. 7B is a section taken on line 7B-7B of FIG. 7A;

FIG. 8A is an enlarged, top side perspective of a base plate;

FIG. 8B is a bottom side perspective of the base plate of FIG. 8A;

FIG. 9A is an enlarged, top side perspective of a clasp;

FIG. 9B is a bottom side perspective of the clasp of FIG. 9A;

FIG. 10 is a perspective similar to FIG. 2 except two base plates are attached to the spine of the cover;

FIG. 11A is a fragmentary perspective similar to FIG. 10 except the ring binder mechanism is shown engaging the base plates;

FIG. 11B is an enlarged schematic perspective taken from FIG. 11A showing a mounting post of the ring binder mechanism in engagement with the base plate;

FIG. 12A is a fragmentary perspective similar to FIG. 11A except the clasp has been moved to a partially pivoted position;

FIG. 12B is an enlarged schematic perspective taken from FIG. 12A showing the clasp in the partially pivoted position;

FIG. 13A is a fragmentary perspective similar to FIG. 12A except the clasp has been fully pivoted so that it cooperates with the base plate to secure the mounting post;

FIG. 13B is an enlarged schematic perspective taken from FIG. 13A showing the clasp and base plate cooperating to secure the mounting post;

FIG. 14 is a section taken on line 14-14 of FIG. 13A;

FIG. 15A is an enlarged, top side perspective of another configuration of a base plate;

FIG. 15B is a bottom side perspective of the base plate of FIG. 15A;

FIG. 16 is a fragmentary perspective of a ring binder mechanism being attached to a spine of a ring binder cover using the base plate shown in FIG. 15A; and

FIG. 17 is a section along line 17-17 of FIG. 16;

Corresponding reference characters indicate corresponding parts throughout the drawings.

### DETAILED DESCRIPTION OF THE INVENTION

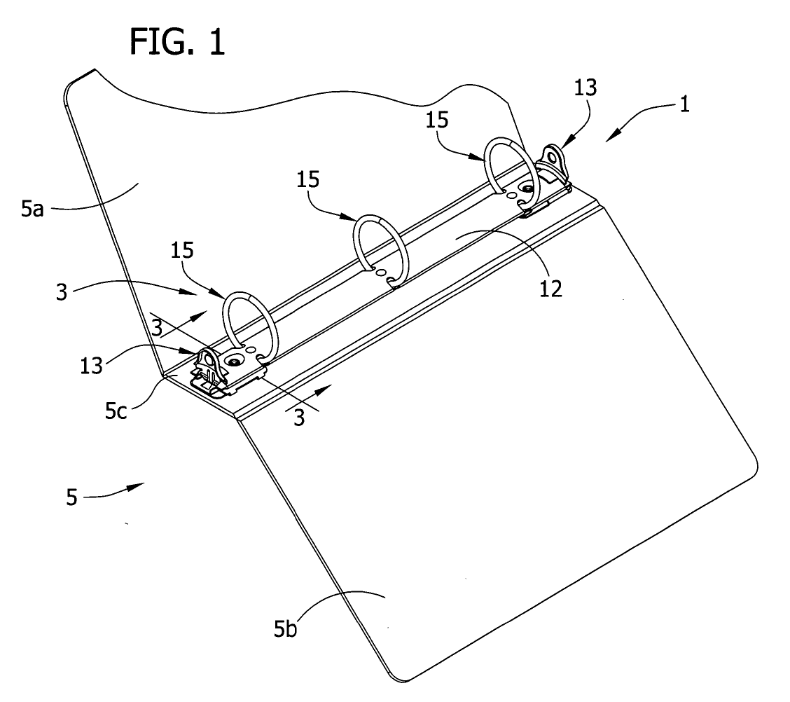

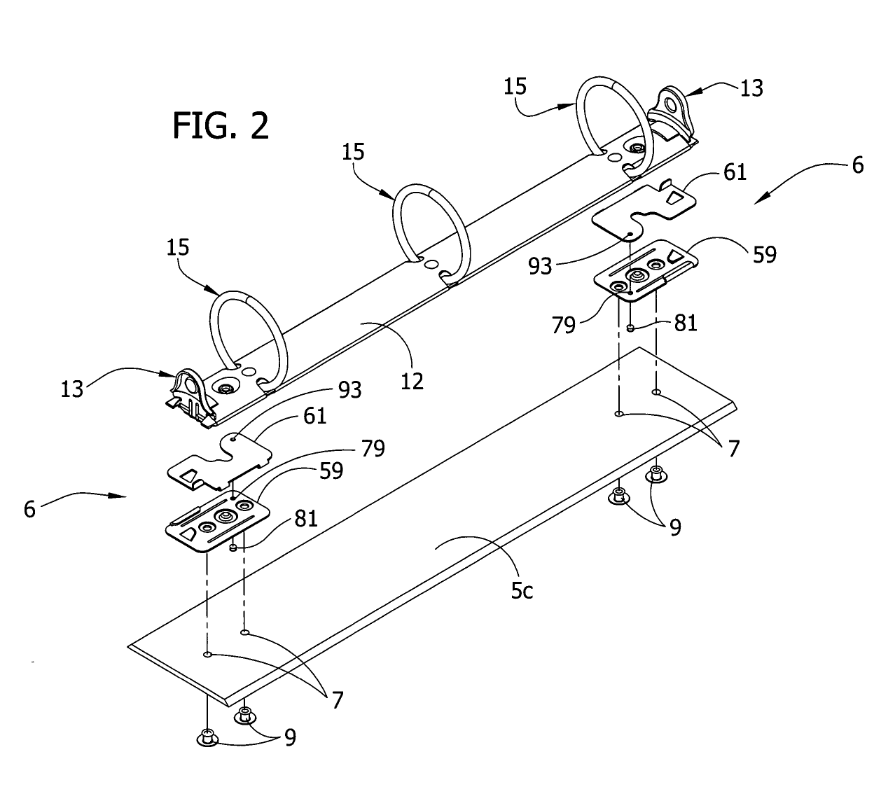

Referring now to the drawings, and particularly to FIGS. 1-3, a ring binder according to the present invention is designated generally by reference numeral 1. The ring binder 1 comprises a ring binder mechanism 3 affixed on a cover 5 (broadly, “a substrate”) using a fastening system 6 of the present invention (the reference numbers designating their subjects generally). The cover 5 includes a front panel 5a, a back panel 5b, and a spine 5c. The front and back panels 5a, 5b are hingedly attached to the spine 5c so that they are movable to selectively cover or expose loose leaf pages (not shown) retained by the ring binder mechanism 3. As shown in FIG. 2, the spine 5c of the cover 5 includes four, axially aligned apertures 7 for receiving rivets 9 to mount the fastening system 6 on the cover. Two of the apertures 7 are located generally adjacent one end of the spine 5c and the other two apertures are located generally adjacent the other end of the spine. The number of apertures 7 may be other than four and be within the scope of the present invention. While the ring binder mechanism 3 is shown affixed on the spine 5c of the cover 5, it is understood that the ring binder mechanism 3 can be affixed on the front panel 5a or the back panel 5b of the cover 5. Moreover, the ring binder mechanism 3 can be mounted on substrates other than the cover 5, such as files, without departing from the scope of the present invention.

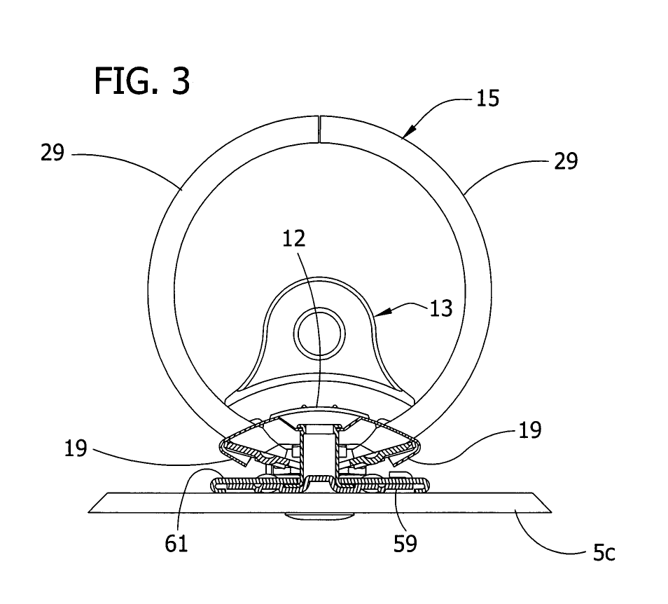

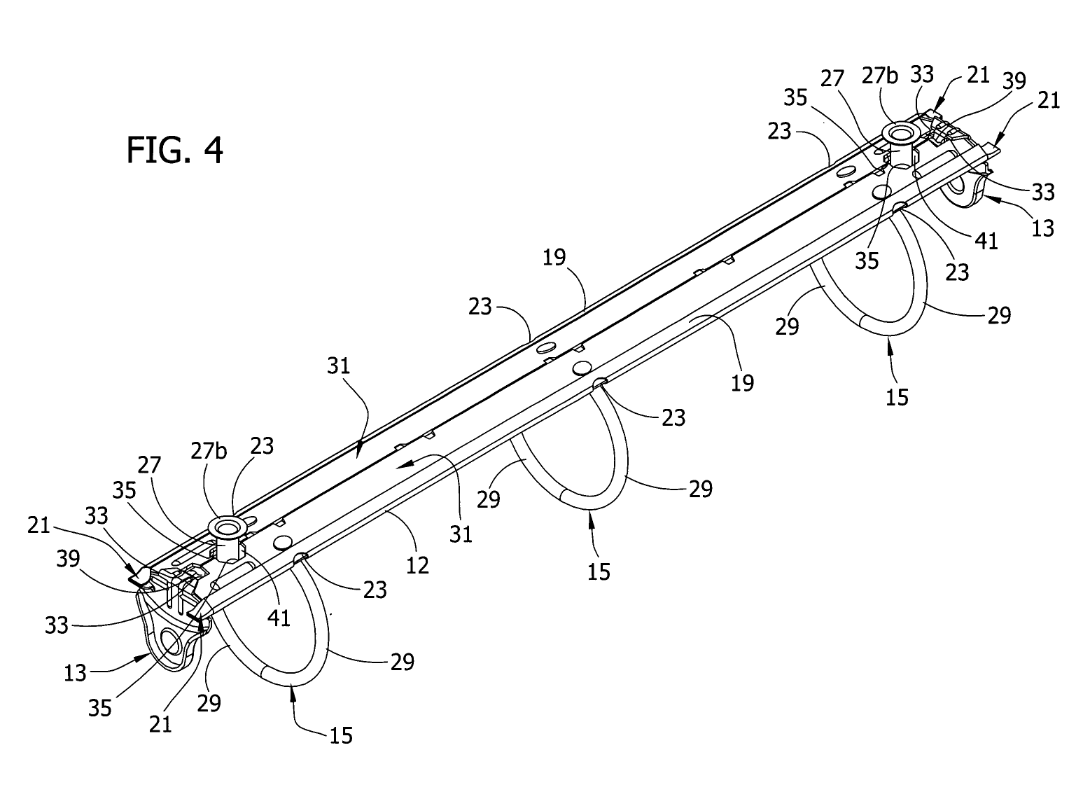

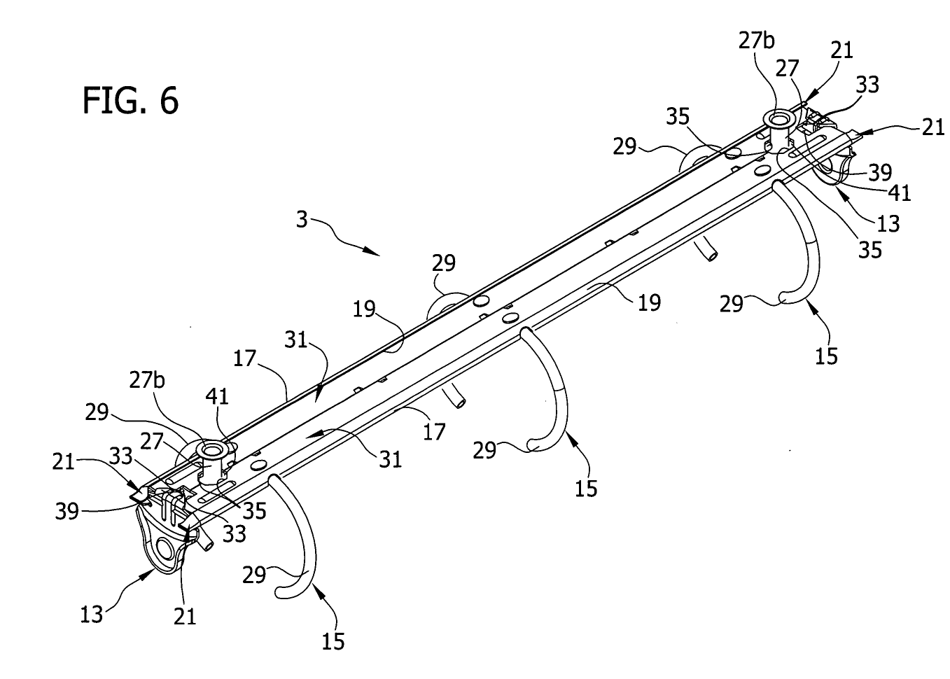

The ring binder mechanism 3 includes an elongate housing 12 that supports two substantially similar actuating levers (each designated generally at 13) and three rings (each designated generally at 15). The housing 12 is symmetrical with a roughly arch-shaped cross section (FIG. 3) and includes a longitudinal axis, two transversely opposite longitudinally extending edges, and two longitudinal ends (FIG. 2). Each lever 13 pivotally mounts on the housing 12, generally at a respective longitudinal end, for controlling movement of the rings 15 between a closed position (FIG. 4) and an open position (FIG. 6).

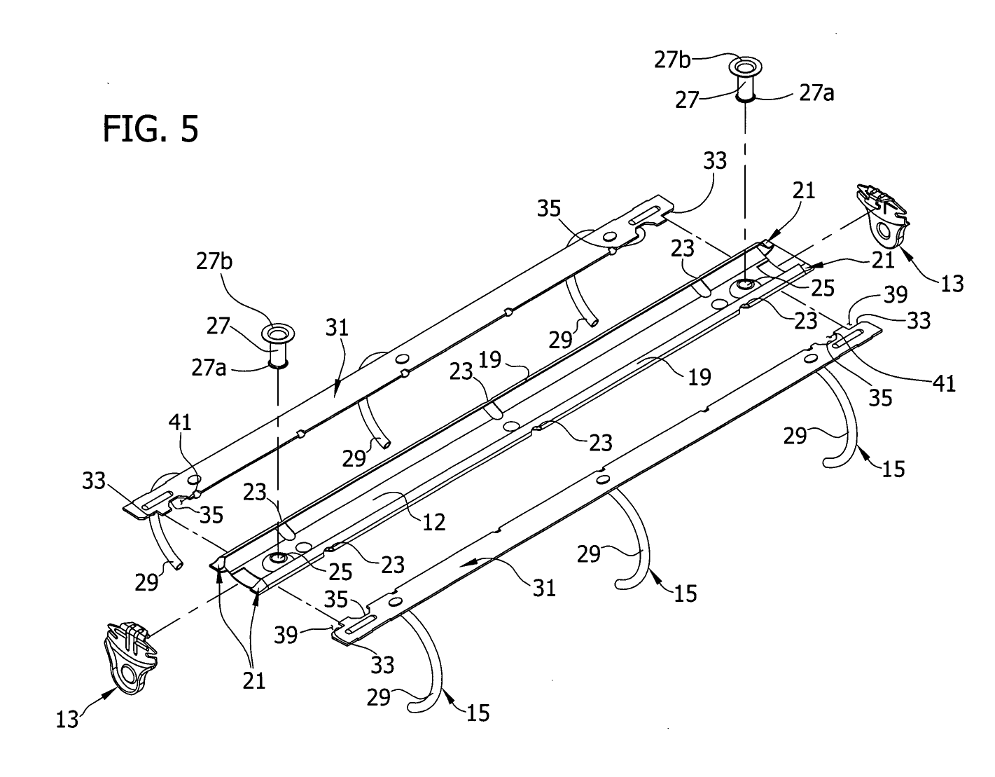

As best shown in FIGS. 3 and 4, a bent under rim 19 formed along each longitudinal edge of the housing 12 extends the full length of the housing from one longitudinal end to the other. Each end of the two bent under rims 19 is pinched together with a portion of an upper surface of the housing 12 to form four pockets (each pocket being designated by reference numeral 21). Accordingly, there are two pockets 21 located at each end of the housing 12. Six total slots 23 are positioned along the two bent under rims 19. The slots 23 are arranged in three transversely opposed pairs with each pair receiving one of the rings 15 therethrough, allowing each ring to move laterally of the housing 12 for opening and closing. Referring to FIG. 5, two additional circular openings 25 are provided in the upper surface of the housing 12, near the longitudinal ends, each receiving and attaching mounting posts 27 (broadly, “connector members”) to the housing 12. It is envisioned that the housing of the present invention is made of metal, but it may be made of any other suitable material that is sufficiently rigid to provide a stable mount for components of the mechanism. In addition, differently shaped housings, including asymmetrical ones, do not depart from the scope of this invention.

Each of the rings 15 includes two ring members 29, which are supported by the housing 12 for movement relative to one another between a closed position (see FIG. 4) and an open position (see FIG. 6). In the closed position, the ring members 29 form a substantially continuous, closed, ring or loop for retaining loose-leaf pages and for allowing the pages to move along the rings 15 from one ring member to the other. In the open position, the ring members 29 form a discontinuous, open loop suitable for adding or removing pages. It is envisioned that the ring members are formed of a conventional, cylindrical rod of suitable material, such as steel. But it is understood that ring members having a different cross section or ring members made of different material do not depart from the scope of the present invention. Although in the illustrated mechanism both ring members can move, mechanisms having one movable ring member and one fixed do not depart from the scope of the invention. In addition, mechanisms with greater or fewer than three rings or with rings that form other shapes, such as slanted “D” shapes, when ring members are closed, do not depart from the scope of this invention.

As shown in FIGS. 4-6, the two ring members 29 of each ring 15 are mounted opposite each other on respective ones of a pair of hinge plates (each hinge plate being designated generally by reference numeral 31). The hinge plates are each thin and elongate, having an inner and an outer longitudinal edge margin and two longitudinal ends. Each hinge plate 31 additionally includes two squared notches 33 and two rounded cutouts 35, each of which are located along the inner longitudinal edge margin of the hinge plate. The two notches 33 are each located at a respective longitudinal end of the hinge plate 31, and the two cutouts 35 are each located inward from a one of the respective notches 33 but still generally adjacent the hinge plate's ends.

Referring again to FIGS. 4 and 6, the hinge plates 31 attach to one another in parallel arrangement along their inner longitudinal edge margins, forming a central hinge having a pivot axis. The housing 12 loosely receives the outer longitudinal edge margins of the interconnected hinge plates 31 above its two bent under rims 19. Thus, the hinge plates 31 are retained on the housing 12 while the outer longitudinal edge margins are free to move within the rims 19. Corresponding notches 33 of the adjoining hinge plates align to form two box-shaped recesses 39 at opposite longitudinal ends of the plates 31. These recesses 39 are sized and shaped to interact with the actuating levers 13, as will be described in more detail hereinafter. Similarly, corresponding cutouts 35 align to form two openings 41, each sized and shaped for receiving one of the mounting posts 27 through the hinge plates 31. In the illustrated ring binder mechanism the box-shaped recesses 39 and the oval openings 41 are both symmetrically positioned about the pivot axis of the interconnected hinge plates 31. However, mechanisms in which openings and recesses are positioned differently about a pivot axis of interconnected hinge plates do not depart from the scope of the present invention.

The housing 12 is slightly narrower than the joined hinge plates 31 when the hinge plates are in a coplanar position (i.e., an angle between exterior surfaces of the hinge plates is 180°). So as the hinge plates 31 pivot through this position, they deform the resilient housing 12 and cause a spring force in the housing that urges the hinge plates 31 to pivot away from the coplanar position, either closing the ring members 29 (i.e., moving the pivot axis down and away from the housing's upper surface (FIG. 4)) or opening them (i.e., moving the pivot axis up and toward the housing's upper surface (FIG. 6)). Moreover, when the ring members 29 are closed, this spring force resists hinge plate movement and clamps the ring members together. When the ring members 29 are open, the spring force holds them apart. Thus, the illustrated embodiment uses a conventional arrangement to move the hinge plates 31 and ring members 29. It will be understood that other ways of moving the rings members 29 and locking them in a closed position or open position may be used within the scope of the present invention.

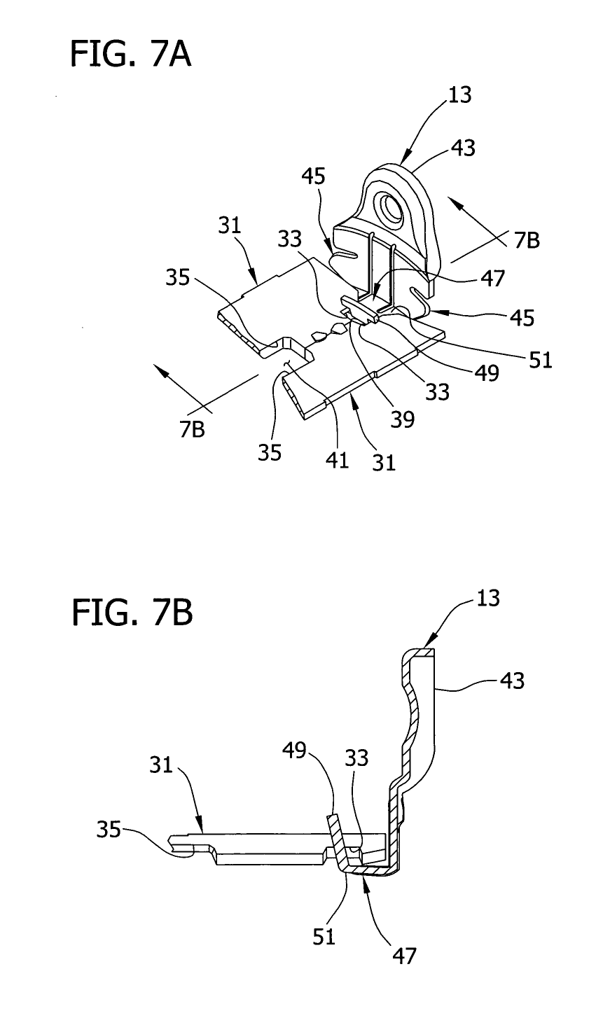

The two actuating levers 13 are generally shown in FIGS. 1, 2, 7A and 7B. Each lever 13 includes a relatively flat head 43 that extends upward, generally above the housing 12, for grasping to pivot the lever. Each additionally includes two lateral arms, each designated by reference numeral 45, and a cam, designated generally by reference numeral 47. As best shown in FIG. 7A, the lateral arms 45 extend laterally outward from opposite sides of each lever 13 below the flat head 43. The two arms 45 of each lever loosely fit within the two pockets 21 located at each longitudinal end of the housing 12, allowing the levers 13 to pivot within the pockets 21 relative to the housing about an axis transverse to the housing (FIGS. 4 and 6). Referring again to FIGS. 7A and 7B, the cam 47 of each lever is integrally attached to the lever 13 below the lateral arms 45. It extends downward from the arms 45 and curves outward from the flat head 43, fitting into one of the respective box-shaped recesses 39 of the hinge plates. An enlarged tab 49 of each cam fits loosely over the interconnected hinge plates 31 while a base 51 of each cam rests below the plates. Together, the tab 49 and base 51 releasably lock the hinge plates 31 therebetween for operable engagement to control the pivoting motion of the hinge plates that close and open the ring members 29. In operation to close the ring members 29, the levers 13 are pivoted upward and inward. The tabs 49 engage a top surface of the hinge plates 31 and pull the pivot axis of the plates downward. To open the ring members 29, the levers 13 are pivoted outward and downward. The bases 51 engage a bottom surface of the hinge plates 31 and push the pivot axis of the plates upward. Mechanisms (not shown) having levers with different shapes or levers pivotally attached to a housing differently do not depart from the scope of the present invention. In addition, mechanisms having only one lever for driving the hinge plates do not depart from the scope of the present invention.

Referring again to FIGS. 4-6, the two mounting posts 27 are located adjacent the levers 13 and space the ring binder mechanism 3 off the cover 5 so that the hinge plates 31 can pivot without engaging the spine 5c of the cover. In this position, the mounting posts 27 align with the oval openings 41 of the interconnected hinge plates 31 and pass through the hinge plates without interfering with their operation. Each mounting post 27 is also tubular in shape and includes two open longitudinal ends. A first end includes a deformable lip 27a for attaching the mounting post to one of the circular openings 25 in the upper surface of the housing 12 (FIG. 5). It will be understood that other ways of attaching the mounting posts 27 to the housing 12 may be used without departing from the scope of the present invention. A second end includes a flange 27b that is folded outward of the mounting post 27 for supporting the ring binder mechanism 3 on the spine 5c of the cover 5. The flange 27b can have other shapes and configurations without departing from the scope of this invention.

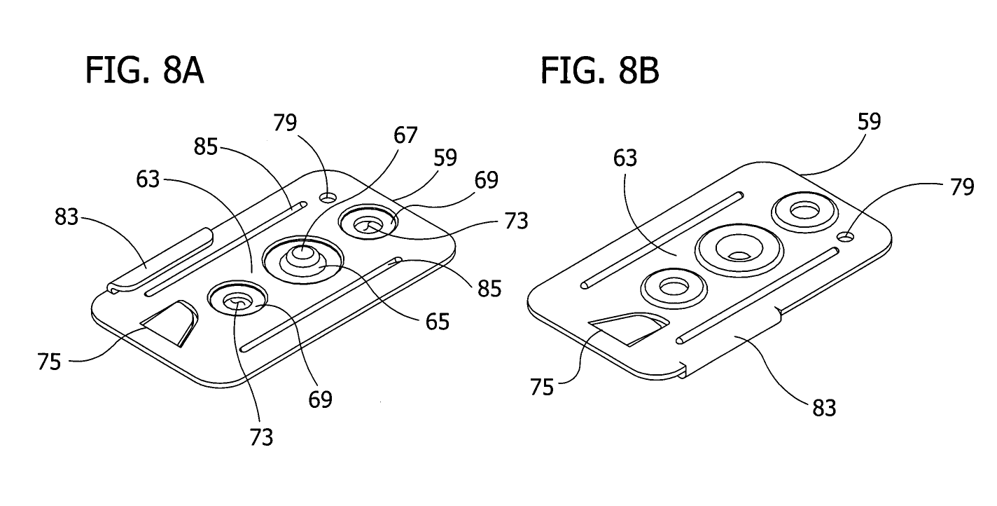

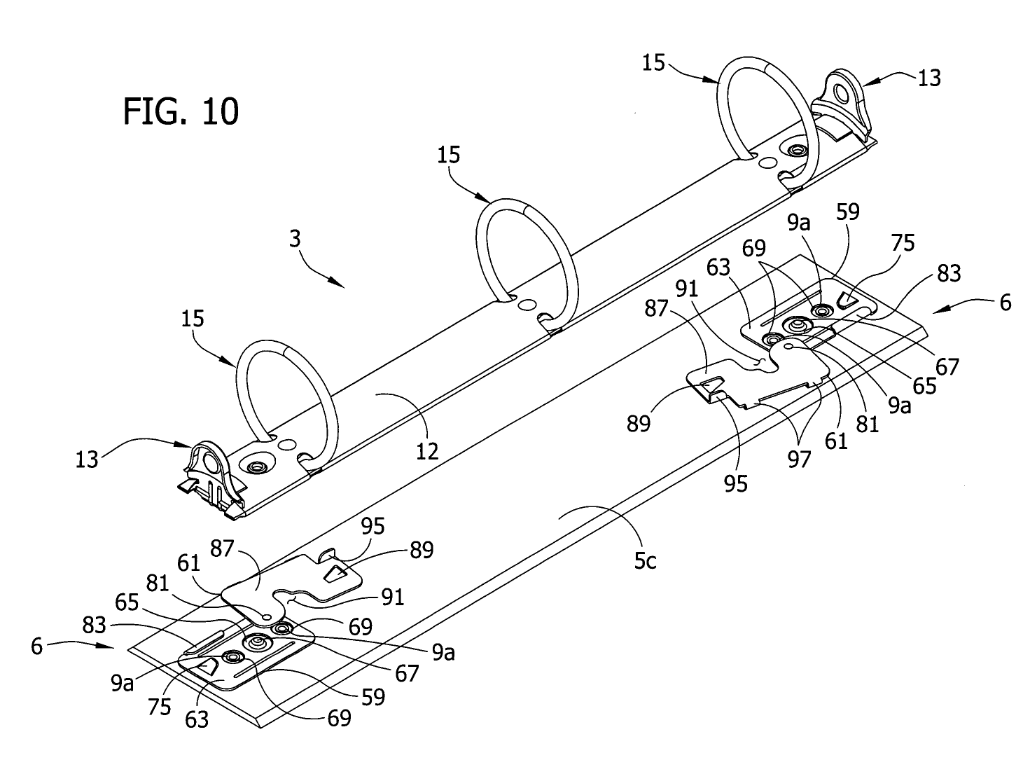

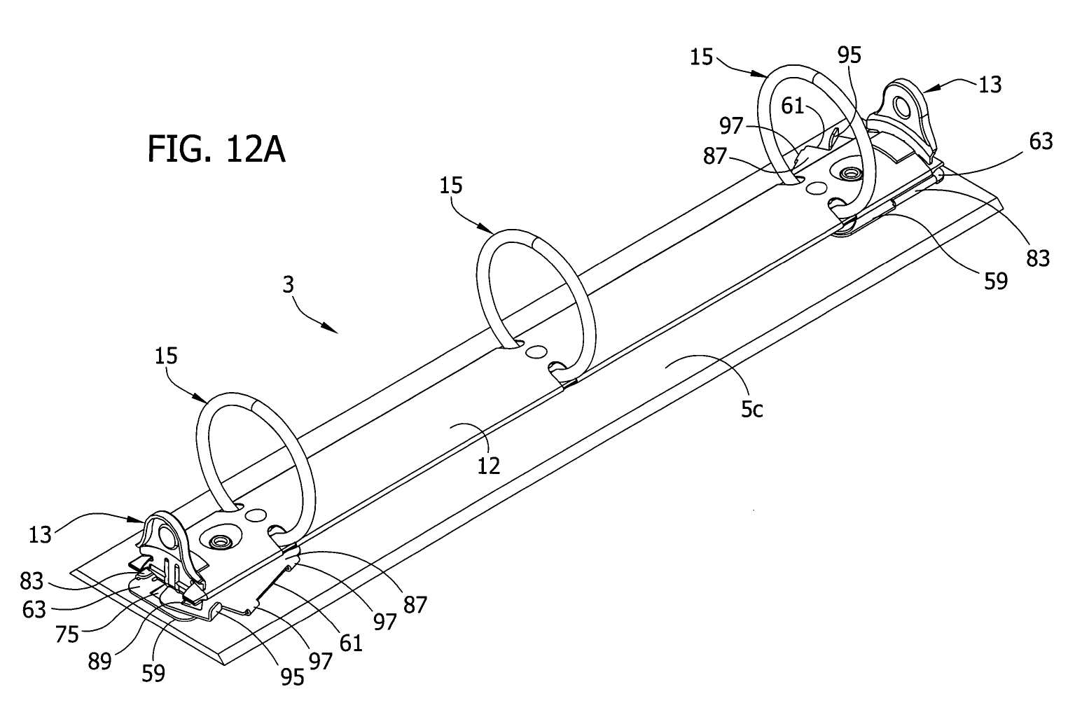

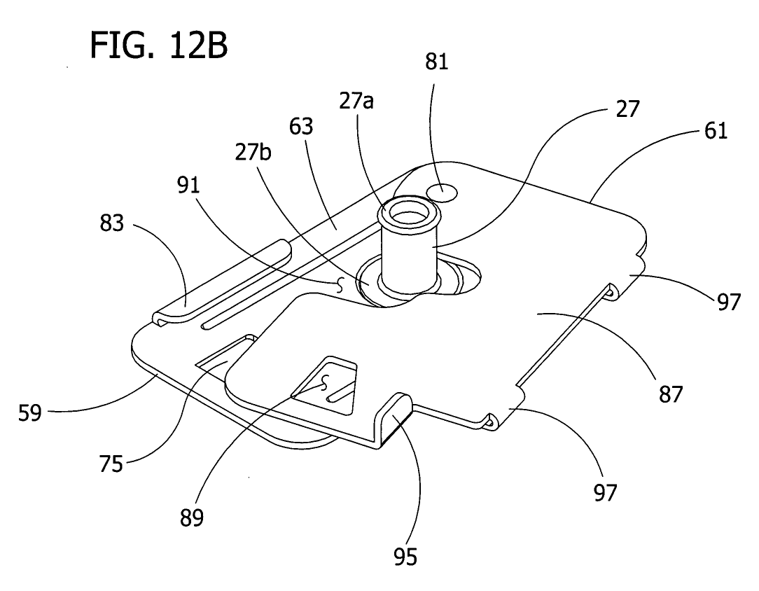

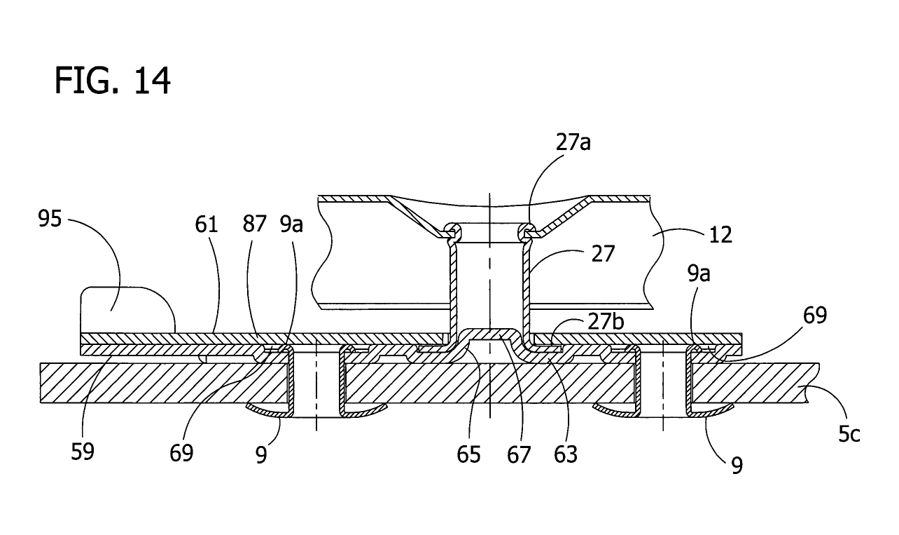

As shown in FIGS. 10-14, the ring binder mechanism 3 is attached to the spine 5c of the cover 5 using the fastening system 6, which includes two base plates 59 and two clasps 61 pivotally connected to respective base plates. Since the two base plates 59 and two clasps 61 are the same only one of each will be described. The base plate 59 comprises a generally rectangular web 63 having an annular seat 65 located near the center of the web and recessed below the surrounding web (FIGS. 8A and 8B). A nub 67 in the center of the seat 65 projects upwardly from the seat. As illustrated in FIG. 14, the seat 65 is adapted to receive the flange 27b of the mounting post 27 and the nub 67 is adapted to extend upward into the tubular body of the mounting post. The recessed seat 65 and nub 67 cooperate to hold the mounting post 27 and ring mechanism 3 from movement laterally with respect to the base plate 59.

Referring again to FIGS. 8A and 8B, the base plate 59 also includes two recesses 69 axially aligned on opposite sides of the seat 65. The recesses 69 have holes 73 for receiving rivets 9 to attach the base plate 59 to the spine 5c of the cover 5. The holes 73 are spaced for aligning with the apertures 7 in the spine 5c of the cover 5 so that the rivets 9 can be inserted through the apertures in the spine and the holes in the recesses. The recesses 69 are sized and shaped to accommodate the bent tails 9a of the rivets 9 so that no portion of the rivet extends above the surface of the web 63. The base plate 59 further comprises a tab 75 having a generally triangular shape. In the illustrated configuration, a tab 75 is cut from the web 63 and a portion of the tab is bent upward to form a protuberance (broadly, “first locking element”). The tab 75 is used to secure the clasp 61 to the base plate 59 as described in move detail below.

The base plate 59 also includes a circular opening 79 adjacent one of its corners for receiving a pin 81 to pivotally connect the clasp 61 to the base plate (FIGS. 2, 8A and 8B). The pin 81 defines the axis on which the clasp 61 pivots with respect to the base plate 59. The base plate 59 also includes a catch 83 located along the longitudinal edge of the base plate nearest the opening 79. The catch 83 prevents the clasp 61 from pivoting beyond the extent on the base plate 59. The illustrated catch 83 extends along approximately one-third of the longitudinal edge of the base plate 59, however, the catch can extend along the longitudinal edge of the base plate a greater or lesser distance. Elongate channels 85 extend adjacent each of the longitudinal edges of the base plate 59 to strengthen the base plate against bending about a transverse axis of the base plate.

Referring again to FIGS. 2 and 10, each of the base plates 59 are securely attached to the cover 5 in predetermined locations using rivets 9. The locations of the base plates 59 are selected based on the desired location of the ring binding mechanism 3. For example, the base plates 59 can be attached to either the spine 5c (as shown), the front panel 5a, or the back panel 5b of the cover 5. Markings (not shown) can be placed on the cover 5 to identify the locations on the cover where the base plates are to be mounted. The spacing between the base plates 59 is determined based on the distance between the mounting posts 27 on the ring binding mechanism 3. As an illustrative example, the mounting posts 27 of the illustrated ring binding mechanism 3 are spaced about 9.5 inches apart. As a result, the base plates 59 will be spaced such that the portions of the base plates adapted to receive the mounting post 27 (i.e., the seats 65) are also spaced about 9.5 inches apart. The dimensions used in this example are illustrative only and it is understood that the base plates can be spaced apart other distances without departing from the scope of this invention. It is also understood that the ring binder could have more or fewer mounting post and base plates without departing from the scope of this invention.

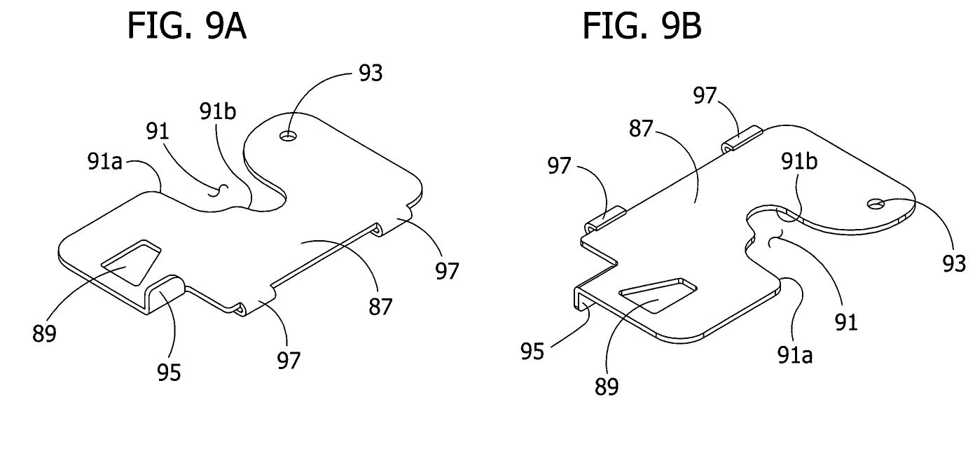

The clasp 61, as shown in FIGS. 9A and 9B, comprises a generally rectangular shaped web 87 having a generally triangular shaped opening 89 (broadly, “second locking element”) that is sized and shaped for receiving the tab 75 of the base plate 59 for securing the clasp against movement with respect to the base plate. The interaction of the tab 75 and the opening 89 is described in more detail below. The clasp 61 further includes a cutout 91 having broad outer portion 91a and a narrow inner portion 91b. The broad outer portion 91a allows the clasp 61 to pivot past the mounting post 27 of the ring binder mechanism 3 while the mounting post is engaged with the base plate 59. The narrow portion 91b is adapted for receiving the tubular body of mounting posts 27 when the clasp 61 is engaged with the base plate 59. The narrow portion 91b has a width less then the width of the flanges 27b of the mounting post to thereby secure the mounting post to the base plate 59.

The clasp also includes an aperture 93 for aligning with the circular opening 79 in the base plate 59 and receiving the pin 81 to pivotally connect the clasp 61 to the base plate (FIGS. 2, 9A and 9B). A grip 95 is provided on the clasp 61 for grasping and pivoting the clasp about the pin 81. As illustrated the grip 95 is formed from a portion of the web 87 but it is understood that the grip could be formed as a separate piece and attached to the web. Two stops 97 having generally C-shaped cross-sections are provided on the clasp 61 to prevent the clasp from pivoting beyond the extent of the base plate 59. When the clasp 61 is engaged with the base plate 59 to secure the mounting post 27, the stops 97 receive and contact the longitudinal edge of the base plate 59 opposite the catch 83.

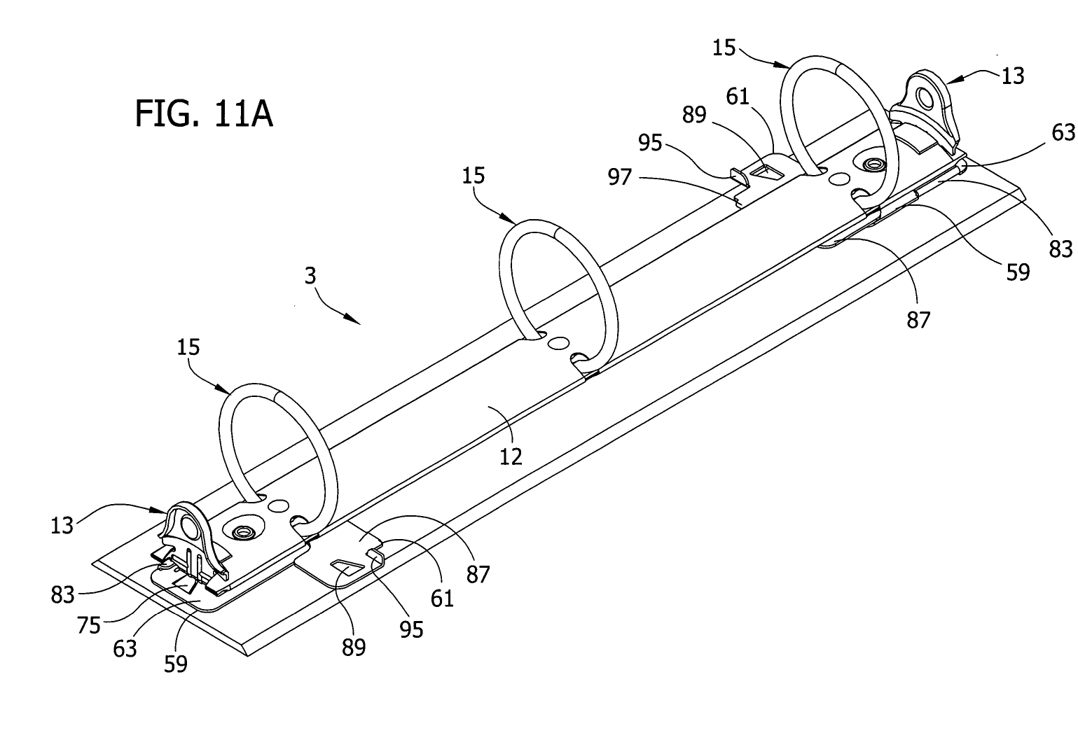

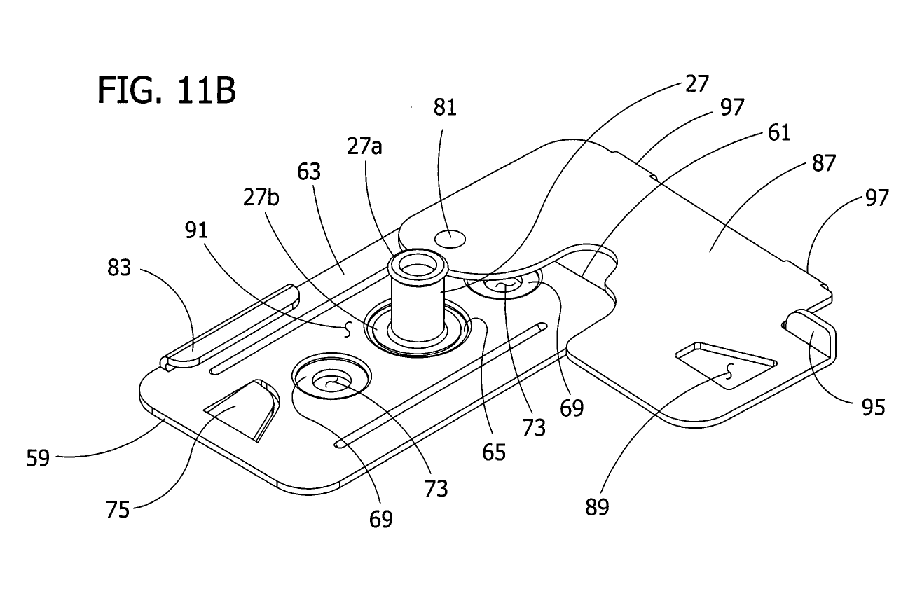

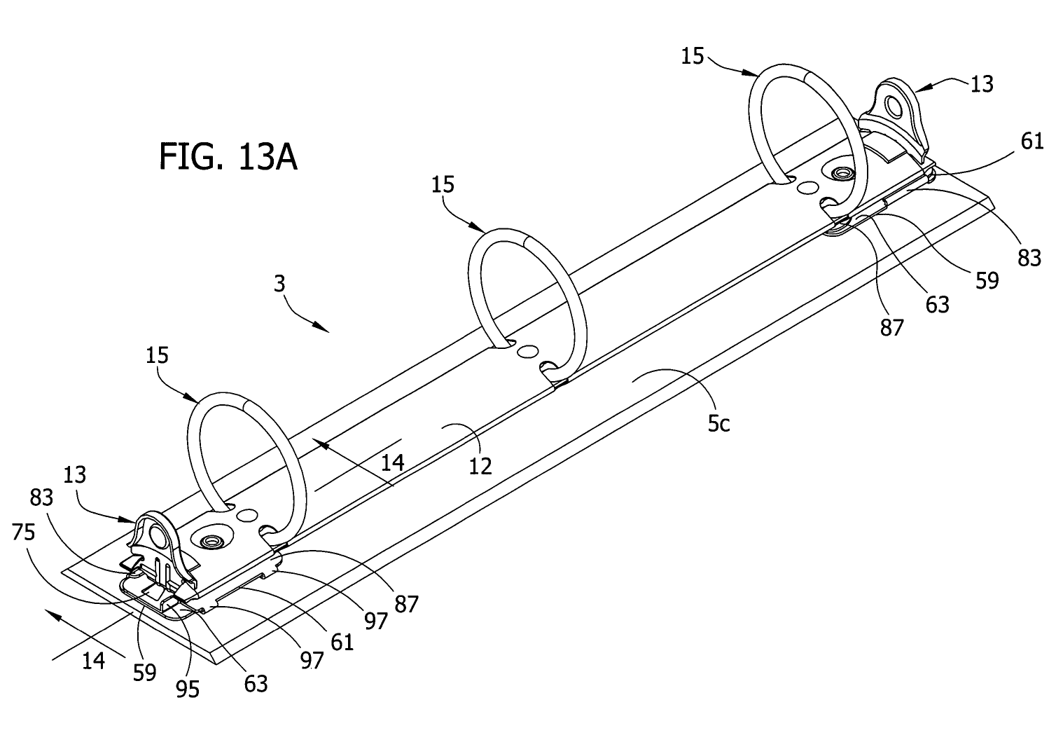

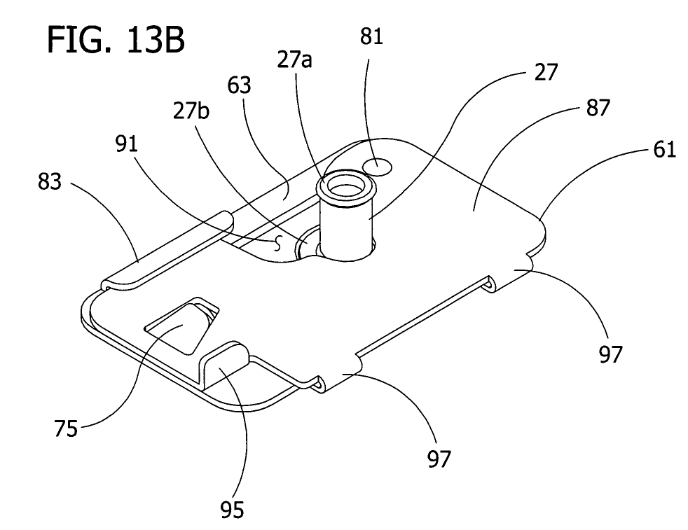

Ring binders 1 of the present invention can be assembled by affixing the base plates 59 (with the clasps 61 pivotally attached) to the spine 5c of the cover 5 using rivets 9 (FIG. 10), engaging the flanges 27b of the mounting posts 27 with the seats 65 of the base plates (FIGS. 11A and 11B), and pivoting the clasps 61 with respect to the base plates from a release position to a lock position to thereby secure the flanges 27b in the seats (FIGS. 13A and 13B). To affix the base plates 59 to the cover 5 as shown in FIG. 10, the holes 73 in the base plates are aligned with the apertures 7 in the spine 5c of the cover. The rivets 9 are inserted through the apertures 7 in the spine 5c and the holes 73 in the base plates 59 so that the tails 9a of the rivets extend through the base plates. The tails 9a of the rivets 9 are bent over to thereby secure the base plates 59 to the cover 5. The bent tails 9a of the rivets 9 are received in the small recesses 69 so that the no portion of the bent tails extend above the surface of the webs 63 of the base plates 59.

Referring now to FIGS. 11A and 11B, with the clasp 61 in a release position, the mounting posts 27 of the ring binder mechanism 3 are placed on the seats 65 of the base plates 59 so that the flanges 27b of the mounting posts engage the seats and the nubs 67 of the seats extend upward into the tubular bodies of the mounting posts. The seats 65 receive the flanges 27b so that portions of the flanges do not extend above the surfaces of the webs 63 of the base plates 59. As a result, the clasps 61 can easily be pivoted over the flanges 27b to the lock position. Referring to FIGS. 13A-14, the catches 83 of the base plates 59 receive the longitudinal edges of the webs 87 of the clasps 61 adjacent the cutouts 91 and the stops 97 of the clasps receive the longitudinal edge of the base plates opposite the catches. Moreover, the tab 75 of the base plates 59 are received in the openings 83 in the clasps 61. Each of the tabs 75, as shown in FIG. 13, is sloped with respect to the web 63 of the base plate 59 so that the tab provides a ramped surface for allowing the web 87 of the clasp 61 to pass over the tab. Moreover, the tab 75 is resiliently deformable so that it deflects downward (i.e., toward the cover 5) as the web 87 of the clasp 61 passes over the base plate 59. Once a trailing edge of the tab 75 passes a leading edge of the opening 89 in the clasp 61, the tab returns to approximately its original shape so that it extends upward (i.e., away from the cover 5) and into the opening. The trailing edge of the tab 75 acts as a stop against the leading edge of the opening 89 to prevent the clasp 61 from being inadvertently disengaged from the base plate 59.

The cutouts 91 in the clasps 61 allow the clasps to pivot past the tubular bodies of the mounting posts 27. When the clasps 61 and base plates 59 are engaged, the tubular bodies of the mounting post 27 are received in the narrow inner portion 91a of the cutout 91. With the clasps 61 secured to the base plates 59, as illustrated in FIG. 13, the flanges 27b are securely held between clasps 61 and the base plates 59 thereby securing the ring binder mechanism 3 to the cover 5. The steps for assembling the ring binder can be reversed to disassemble the ring binder (i.e., remove the ring binder mechanism 3 from the cover 5). To remove the clasps 61 from engagement with the base plates 59, however, the tabs 75 need to be deflected downward using a tool (not shown) so that leading edges of the openings 83 can be passed over trailing edges of the tabs.

Accordingly, ring binders of the present invention can be packaged, shipped, stored and/or sold without having the ring binder mechanism 3 attached to the cover 5. For example, the covers 5 with the fastening system 6 attached thereto can be packaged so that little space between adjacent covers is wasted. This can be done by lying the covers 5 flat such that the front panel 5a, back panel 5b, and spine 5c are all substantially in the same plane and stacking others on top. The ring binder mechanisms 3 can be packaged in the same container as the covers 5 or separately. Either way, the ring binder mechanism 3 can be arranged to minimize wasted space. One possible packing arrangement for the ring binder mechanisms 3 is to pack them in alternating directions such that the rings 15 of one mechanism are positioned between the rings of an adjacent mechanism. The separated covers 5 and ring binder mechanisms 3 can be packaged, shipped, and stored more efficiently and cost effectively than covers having the ring binder mechanisms attached.

The ring binder mechanism 3 and covers 5 can be attached, for example, by the retailer prior to transferring them to a customer (i.e, after a sale) or before placing them on display. It is also understood that the customer may wish to maintain the ring binder mechanism 3 and covers 5 separately to take advantage of the saved storage space. Thus, the customer may be the one who attaches the ring binder mechanism 3 to the cover 5. Accordingly, it is understood that the ring binder mechanism 3 and cover 5 of the present invention can be joined to form a ring binder 1 at any of various times. The examples of the ring binder mechanism 3 being attached to the cover 5 by a retailer and an end user are exemplary only as it is understood that other individuals, including the ring binder manufacturer, may assemble the ring binder. It is also understood that the ring binder mechanism could be attached to the cover using an automated process as well as the manual process described herein.

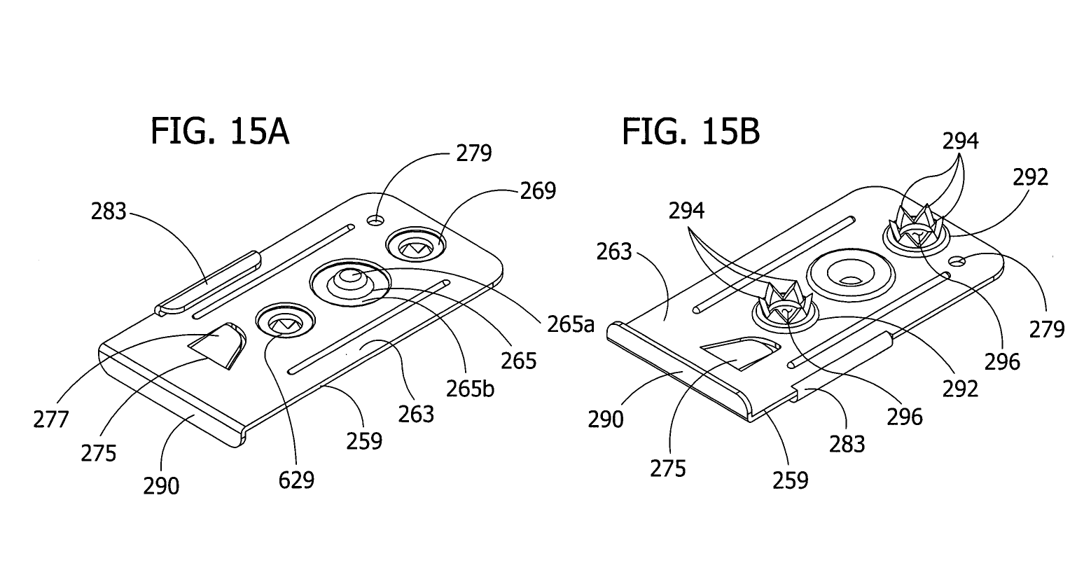

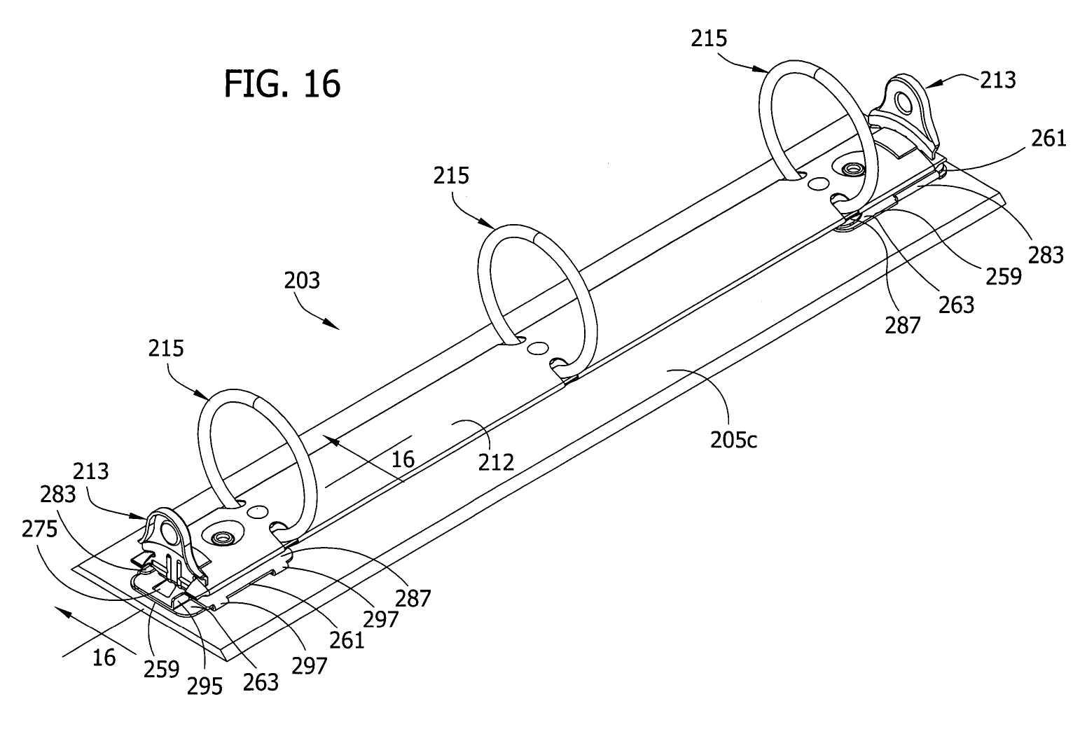

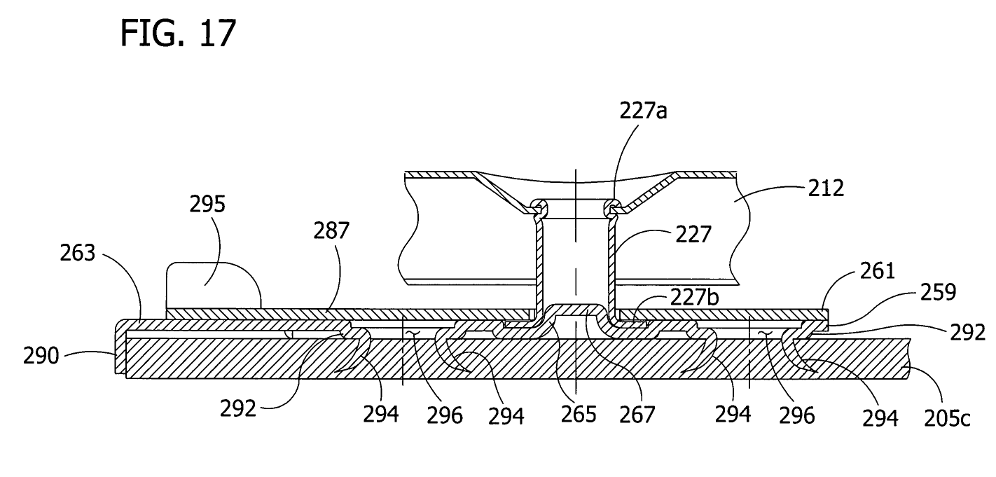

FIGS. 15A-17 show a configuration of a base plate 259 that is substantially similar to the previous described base plate 59 except that the base plate 259 of this configuration has a lip 290 that extends downward from the web 263 of the base plate for protecting a portion of an edge of a cover 205 when the base plate is attached thereto. In addition, the base plate 259 of this configuration is affixed to the cover 205 using prong fasteners 292 instead of rivets. In the illustrated configuration, two prong fasteners 292 extend outwardly from the bottom surface of the base plate 259 and are used to secure each of the plates to the cover 205. Each prong fastener 292 has six, generally triangular prongs 294 struck from the base plate 259 leaving a circular opening 296. As illustrated in FIG. 17, the prongs 294 can be pressed into the cover 205 to effect the fastening of the base plate 259 to the notebook. The bottom surface of the base plates can have more or fewer prong fasteners. Parts corresponding to those in FIGS. 1-14 are indicated by the same reference numbers plus “200”. The exact configuration of the prong fasteners can be other than those described within the scope of the present invention. Moreover, the lip feature may be used with base plates attached in any suitable manner to a substrate.

Components of the mechanism of the present invention are made of a suitable rigid material, such as metal (e.g., steel). But mechanisms made of a non-metallic material, specifically including plastic, do not depart from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations thereof is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A ring binder mechanism comprising:
a housing;
at least one ring supported by the housing for mounting loose leaf paper;
at least one connector member extending outwardly from the housing;
a base plate adapted to be attached to a substrate, the base plate having a surface adapted to receive the connector member of the ring binder mechanism; and
a clasp adapted for movement with respect to the base plate between a release position in which the connector member is unconnected to the base plate and a lock position in which the connector member of the ring binding mechanism is connected to the base plate.

2. The ring binder mechanism as set forth in claim 1 wherein the clasp is mounted on the base plate for motion relative thereto.

3. The ring binder mechanism as set forth in claim 2 wherein the clasp is pivotally mounted on the base plate.

4. The ring binder mechanism as set forth in claim 3 wherein at least one of the clasp and the base plate includes a flange for limiting rotation of the clasp.

5. The ring binder mechanism as set forth in claim 1 wherein the clasp includes a cutout for receiving the connector member in the lock position.

6. The ring binder mechanism as set forth in claim 5 wherein the cutout includes a broad outer portion arranged to provide clearance between the clasp and connector member upon movement of the clasp, and a narrow inner portion having a width less then a width of the broad outer portion.

7. The ring binder mechanism as set forth in claim 1 wherein the base plate includes a first locking element, and the clasp includes a second locking element for engaging the first locking element to thereby lock the clasp to the base plate in the lock position.

8. The ring binder mechanism as set forth in claim 7 wherein the first locking element is a tab and the second locking element is an opening sized and shaped for receiving the tab.

9. The ring binder mechanism as set forth in claim 1 wherein the connector member of the ring binder mechanism comprises a mounting post and a flange at the end of the post.

10. The ring binder mechanism as set forth in claim 9 wherein the base plate includes a seat for receiving the flange of the connector member.

11. The ring binder mechanism as set forth in claim 10 wherein the base plate further includes a nub adjacent to the seat, the nub being adapted to extend upward into the mounting post.

12. The ring binder mechanism as set forth in claim 1 wherein the base plate comprises a web and a lip so that when the base plate is attached to the substrate the lip extends downward thereby covering a portion of an edge of the substrate.

13. The ring binder mechanism as set forth in claim 1 further comprising a fastener, and wherein the base plate includes at least one recess having an opening therein, the recess being sized and shape to accommodate the fastener so that no portion of the fastener extends beyond the recess when the fastener is attached to the base plate.

14. The ring binder mechanism as set forth in claim 1 in combination with the substrate, the ring binder mechanism further comprising a fastener, the base plate being affixed to the substrate using the fastener.

15. The ring binder mechanism and substrate as set forth in claim 14 wherein the substrate comprises a ring binder cover.

16. A fastening system for attaching a ring binder mechanism to a cover, the ring binder mechanism having a housing including at least one ring for mounting loose leaf paper and at least one connector member extending outwardly from the housing, the fastening system comprising;
a base plate adapted to be attached to the cover and having a seat sized and shaped for receiving the connector member of the ring binder mechanism; and
a clasp adapted for movement with respect to the base plate between a release position in which the connector member is unconnected to the base plate and a lock position in which the connector member of the ring binding mechanism is connected to the base plate.

17. The fastening system as set forth in claim 16 wherein the clasp is mounted on the base plate for motion relative thereto.

18. The fastening system as set forth in claim 17 wherein the clasp is pivotally mounted on the base plate.

19. The fastening system as set forth in claim 18 wherein at least one of the clasp and the base plate includes a flange for limiting rotation of the clasp.

20. The fastening system as set forth in claim 16 wherein the clasp includes a cutout for receiving the connector member in the lock position.

21. The fastening system as set forth in claim 20 wherein the cutout includes a broad outer portion arranged to provide clearance between the clasp and connector member upon movement of the clasp, and a narrow inner portion having a width less then a width of the broader portion.

22. The fastening system as set forth in claim 16 wherein the base plate includes a first locking element, and the clasp includes a second locking element for engaging the first locking element to thereby lock the clasp to the base plate in the lock position.

23. The fastening system as set forth in claim 16 wherein the base plate includes a seat for receiving a portion of the connector member.

24. The fastening system as set forth in claim 16 wherein the base plate comprises a web and a lip so that when the base plate is attached to the substrate the lip extends downward thereby covering a portion of an edge of the substrate.

25. A method of attaching a ring binder mechanism to a cover, the ring binder mechanism comprising a housing including at least one ring for mounting loose leaf paper thereon and at least one connector member extending outwardly from the housing, the method comprising:
attaching at least one base plate to the cover, the base plate being adapted to receive a portion of the connector member;
engaging the connector member of the ring binder mechanism with the base plate; and
pivoting a clasp with respect to the base plate, the clasp and base plate cooperating to secure the connector member of the ring binder mechanism to the cover.

26. The method as set forth in claim 25 wherein attaching the base plate to the cover comprises attaching two base plates to the cover.

27. The method as set forth in claim 25 further comprising locking the clasp from pivotal movement with respect to the base plate.
